(19) United States
(12) Patent Application Publication
(10) Pub. No.: US 2007/0258653 A1
(43) Pub. Date: Nov. 8, 2007

(54) Unit for and Method of Image Conversion

(75) Inventors: Franciscus Hendrikus Van Heesch, Eindhoven (NL); Michiel Adriaanszoon Klompenhouwer, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,276

(22) PCT Filed: Aug. 4, 2005
(86) PCT No.: PCT/IB05/52609

§ 371 Date: Feb. 6, 2007

(30) Foreign Application Priority Data
Aug. 10, 2004 (EP) 04103857.1

(51) Int. Cl. G06K 9/36

(52) U.S. Cl. 382/248

(57) ABSTRACT

An image conversion unit (100) for converting an input image with an input frequency spectrum into an output image with an output frequency spectrum, the output frequency spectrum having more relatively high frequency components than the input frequency spectrum is disclosed. The image conversion unit comprises: means for providing (102) an intermediate image on basis of the input image; and combining means (104) for combining a high frequency signal with the intermediate image into the output image by means of error diffusion.

The invention relates to an image conversion unit for converting an input image with an input frequency spectrum into an output image with an output frequency spectrum, the output frequency spectrum having more relatively high frequency components than the input frequency spectrum.

The invention further relates to an image processing apparatus comprising such an image conversion unit.

The invention further relates to a method of converting an input image with an input frequency spectrum into an output image with an output frequency spectrum, the output frequency spectrum having more relatively high frequency components than the input frequency spectrum.

The invention further relates to a computer program product to be loaded by a computer arrangement, comprising instructions to convert an input image with an input frequency spectrum into an output image with an output frequency spectrum, the output frequency spectrum having more relatively high frequency components than the input frequency spectrum.

The advent of HDTV emphasizes the need for spatial up-conversion techniques that enable standard definition (SD) video material to be viewed on high definition (HD) television (TV) displays. Conventional techniques are linear interpolation methods such as bi-linear interpolation and methods using poly-phase low-pass interpolation filters. The former is not popular in television applications because of its low quality, but the latter is available in commercially available ICs.

Additional to the conventional linear techniques, a number of non-linear algorithms have been proposed to achieve this up-conversion. Sometimes these techniques are referred to as content-based or edge dependent spatial up-conversion. Some of the techniques are already available on the consumer electronics market.

With the known up-conversion methods, the number of pixels in the frame is increased, but the perceived sharpness of the image is not or hardly increased. Although the non-linear methods perform better than the linear methods, in this aspect, many up-converted images often look flat or unnatural. In other words, the capability of the display is not fully exploited.

Often a spatial up-conversion is succeeded by sharpness enhancement. However a disadvantage of known sharpness enhancements is that noise which is present in an input image is amplified and may be clearly visible in the output image. To prevent that, noise reduction may be performed prior to conversion and sharpness enhancement. A disadvantage of current noise reduction techniques is that high frequency image content is reduced.

Despite the reduction of noise, a trade-off remains between the decree of sharpness enhancement and the amount of noise.

It is an object of the invention to provide an image conversion unit of the kind described in the opening paragraph which is arranged to provide an output image with less visible noise.

This object of the invention is achieved in that the image conversion unit comprises:

means for providing an intermediate image on basis of the input image; and

combining means for combining a high frequency signal with the intermediate image into the output image by means of error diffusion.

The image conversion unit according to the invention is arranged to transform the noise that is present in the input signal to the high spatial frequencies by first adding a high frequency signal, i.e. an error signal, followed by error diffusion of the introduced error. The characteristics of the error signal determine the ability to reduce the visibility of noise. They are chosen such that the visibility of mid-frequencies present in the intermediate image, is reduced at the expense of increasing the noise at higher frequencies. Because the HVS (Human Visual System) is less sensitive for high frequencies the overall noise perception decreases.

Noise can also consist of coding artefacts.

Error diffusion, also known as “half-toning”, is a known technique to reduce quantization artefacts. See for instance the article “A comparative study of digital half-toning techniques”, by Chen, J. -S. at Aerospace and Electronics Conference, 1992. NAECON 1992., Proceedings of the IEEE 1992 National, 18-22 May 1992 Pages: 1139-1145 vol. 3 an the article “Linear color-separable human visual system models for vector error diffusion halftoning”, by Evans, B. L., in Signal Processing Letters, IEEE Volume: 10 , Issue: 4, April 2003, Pages: 93-97. In those cases, error diffusion recursively spreads the quantization error to a local neighborhood, effectively shaping the error to high spatial frequencies. This results in a reduction of the visibility of errors.

In the image conversion unit according to the invention, the effect of applying an error signal, i.e. locally adding the high frequency signal, is compensated by subtracting compensation values in the local neighborhood. Typically, the sum of compensation values is equal to the amount being added.

In an embodiment according to the invention, the means for providing an intermediate image comprises an interpolation unit for computing the intermediate image on basis of the input image whereby the resolution of the intermediate image is higher than the resolution of the input image. It is advantageous to apply the combining means according to the invention in combination with an interpolation unit which is arranged to perform spatial up conversion.

Alternatively, the means for providing corresponds to a receiving unit which is arranged to perform a unitary operation, i.e. a copy or lookup table operation. An embodiment according to invention may be advantageous to convert an input signal with a relatively low bandwidth, i.e. a relatively low number of high frequency components compared to be spatial resolution of the images which are represented by the input signal. For instance an input signal which comes from a storage medium like a VCR or DVD whereby high frequency components have been removed from an original signal before storage of the signal, e.g. for reasons of storage capacity. Something similar may have happened with a signal which has been transmitted over a transmission line with limited bandwidth.

An embodiment of the image conversion unit according to the invention, further comprises high frequency generating means for generating the high frequency signal whereby the high frequency signal comprises spectral components that are in a part of the output frequency spectrum that is above the Nyquist frequency of the input image. Adding the high frequency signal to the part of the output spectrum that is above the Nyquist frequency of the input image results in a lower perceived noise level.

In an embodiment of the image conversion unit according to the invention, the high frequency generating means comprises a non-linear filter for generating the high frequency signal on basis of the input image. The high frequency signal is chosen such that it has little influence on the perception of the image content, while simultaneously having a maximum influence on the noise masking. Therefore, preferably a signal is created containing mainly high frequencies with a binary distribution, i.e. containing only the minimum and maximum signal values. Such a signal is preferably created by a sequence of a high pass filter, a clipping unit and an amplification unit.

Preferably, the combining means are adaptive. In an embodiment of the image conversion unit according to the invention, the coefficients of an error diffusion kernel of the combining means are based on local luminance values of the intermediate image. For instance, including only those pixels in the error diffusion kernel that reduce the local contrast. This allows for a trade-off between a decrease of noise and extra blur. Alternatively, the coefficients of the error diffusion kernel of the combining means are based on a scaling factor for the interpolation unit, the scaling factor being based on the relation between the resolution of the intermediate image and the resolution of the input image.

Adding the high frequency signal to the intermediate image can cause the output to reach values beyond a predetermined output range. To prevent this, the combined signal is clipped between the minimum and maximum allowed value of the output range. So, an embodiment of the image conversion unit according to the invention comprises clipping means for clipping the output of the combining means whereby the combining means is arranged to take into account the amount of clipping by the clipping means.

A further embodiment of the image conversion unit according to the invention is arranged to modulate the amplitude of the high frequency signal on basis of a noise level. Preferably the noise measurement is performed on basis of the input image. The noise measurement might be performed by means of a noise measurement unit which is comprised by the image conversion unit, but alternatively the present amount of noise is measured by means of a noise measurement unit that is located externally. In the latter case the image conversion unit is provided with a noise signal indicating the amount of noise, i.e. the present noise level. An advantage of this embodiment according to the invention is that the amount of noise reduction is adapted to the image content. For instance, in the case of an input image with a relatively low amount of noise, the amount of energy, i.e. the amount of added high frequency components should be relatively small to prevent the output image to become too noisy. Preferably, the noise measurement unit is arranged to determine the noise level in dependence of local luminance values of the input image. Preferably, the noise measurement unit provides a signal indicating the local noise level for relatively small areas. With relatively small is meant an area which is smaller than a typical block size which is applied for coding, e.g. 8*8 pixels. Preferably the noise measurement unit provides a signal indicating block edges and ringing noise.

It is a further object of the invention to provide an image processing apparatus of the kind described in the opening paragraph which is arranged to provide an output image with less visible noise.

This object of the invention is achieved in that the image conversion unit of the image processing apparatus comprises:

means for providing an intermediate image on basis of the input image; and

combining means for combining a high frequency signal with the intermediate image into the output image by means of error diffusion.

The image processing apparatus optionally comprises a display device for displaying the output image. The image processing apparatus might e.g. be a TV, a set top box, a VCR (Video Cassette Recorder) player or a DVD (Digital Versatile Disk) player.

It is a further object of the invention to provide a method of the kind described in the opening paragraph which is arranged to provide an output image with less visible noise.

This object of the invention is achieved in that the method comprises:

providing an intermediate image on basis of the input image; and

combining a high frequency signal with the intermediate image into the output image by means of error diffusion.

It is a further object of the invention to provide a computer program product of the kind described in the opening paragraph which is arranged to provide an output image with less visible noise.

This object of the invention is achieved in that the computer program product, after being loaded, provides said processing means with the capability to carry out:

providing an intermediate image on basis of the input image; and

combining a high frequency signal with the intermediate image into the output image by means of error diffusion.

Modifications of the image conversion unit and variations thereof may correspond to modifications and variations thereof of the image processing apparatus, the method and the computer program product, being described.

These and other aspects of the image conversion unit, of the image processing apparatus, of the method and of the computer program product, according to the invention will become apparent from and will be elucidated with respect to the implementations and embodiments described hereinafter and with reference to the accompanying drawings, wherein:

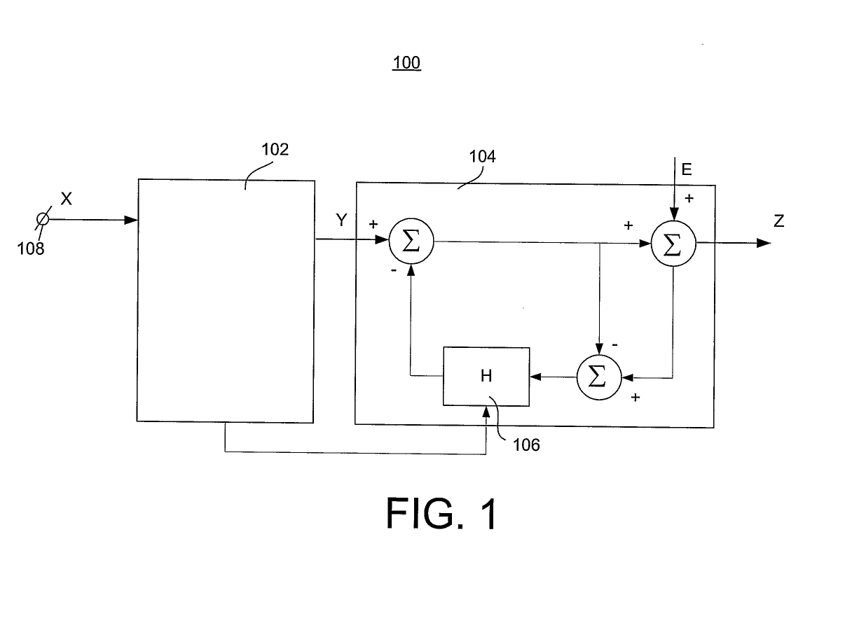

FIG. 1 schematically shows an embodiment of the image conversion unit according to the invention;

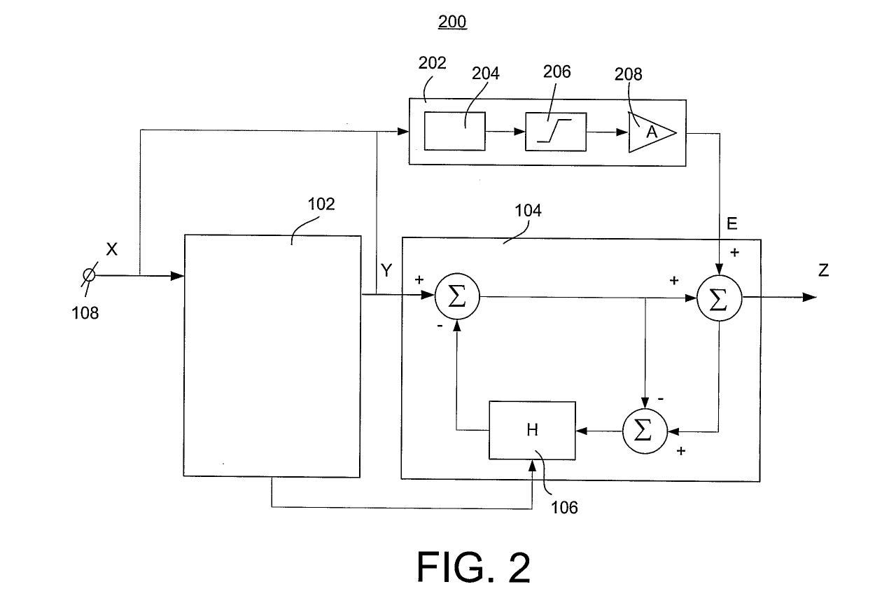

FIG. 2 schematically shows an embodiment of the image conversion unit according to the invention, comprising a high frequency generating unit;

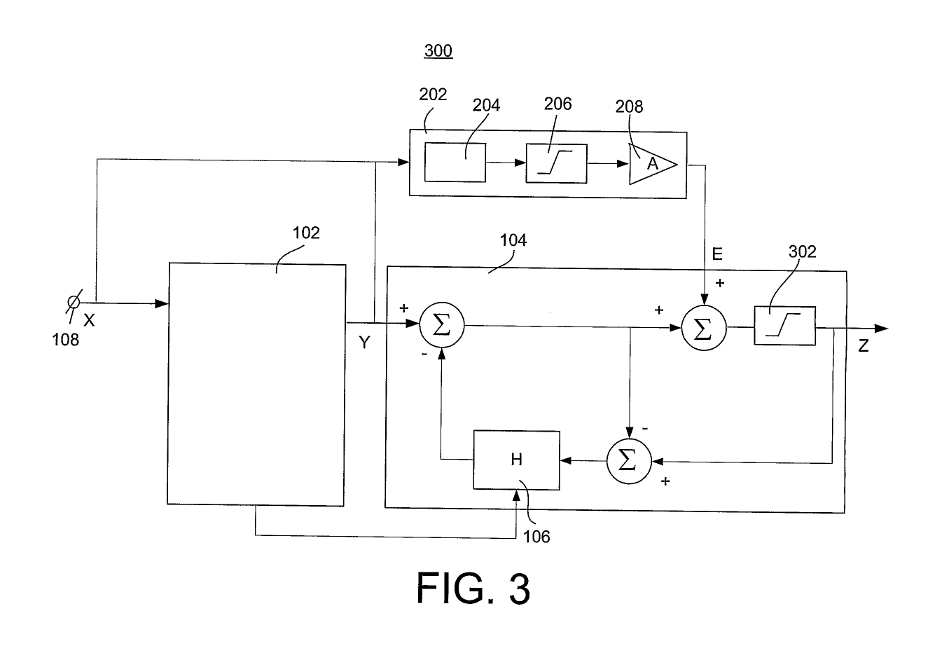

FIG. 3 schematically shows an embodiment of the image conversion unit according to the invention, comprising a clipping unit;

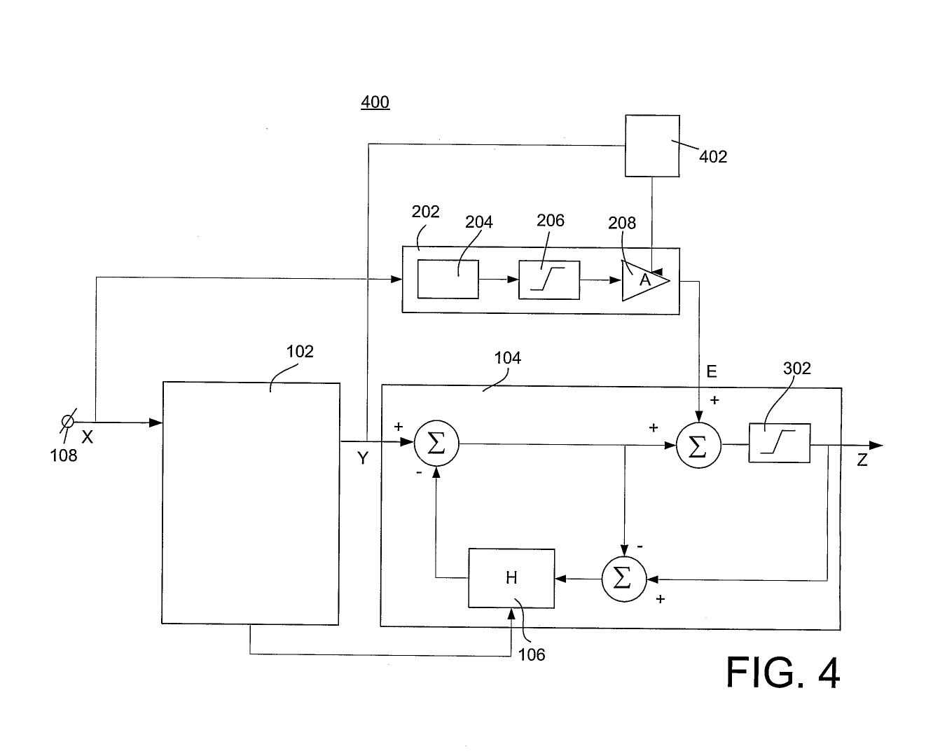

FIG. 4 schematically shows an embodiment of the image conversion unit according to the invention, comprising a noise measurement unit;

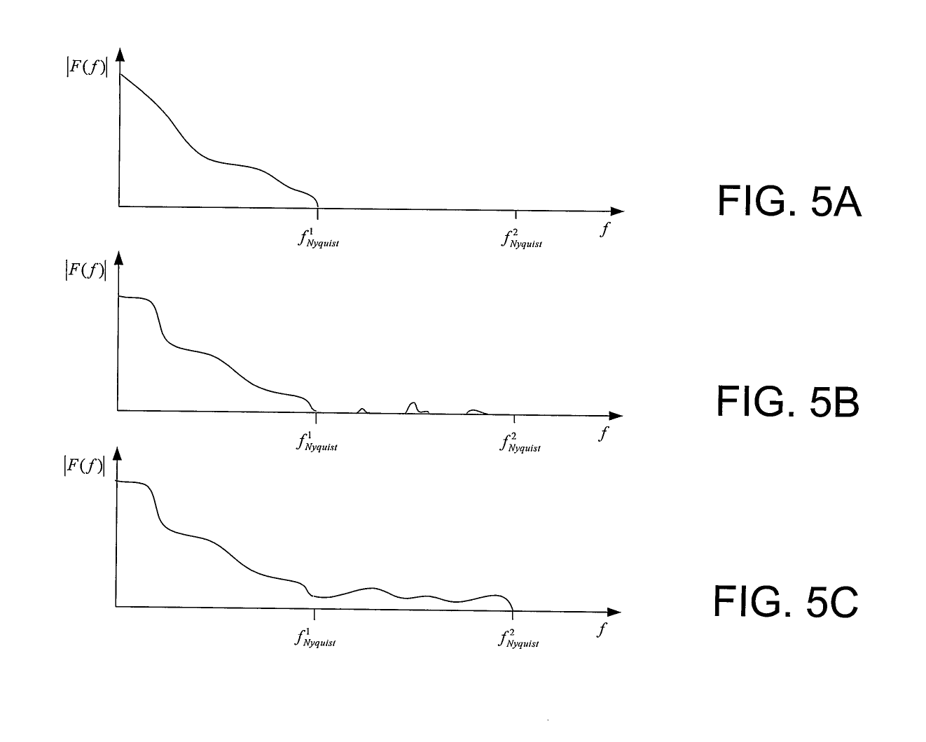

FIG. 5A schematically shows the frequency spectrum of an input SD image;

FIG. 5B schematically shows the frequency spectrum of an intermediate HD image; and

FIG. 5C schematically shows the frequency spectrum of an output HD image;

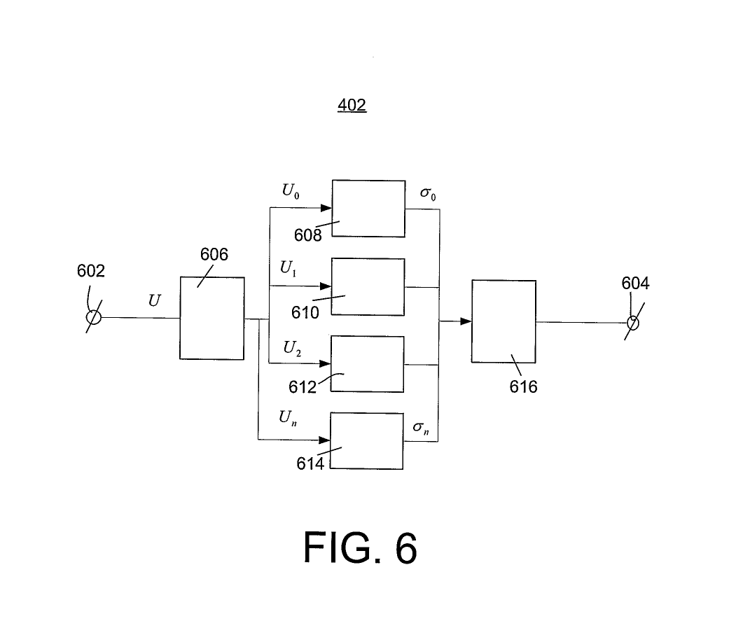

FIG. 6 schematically shows a preferred noise measurement unit; and

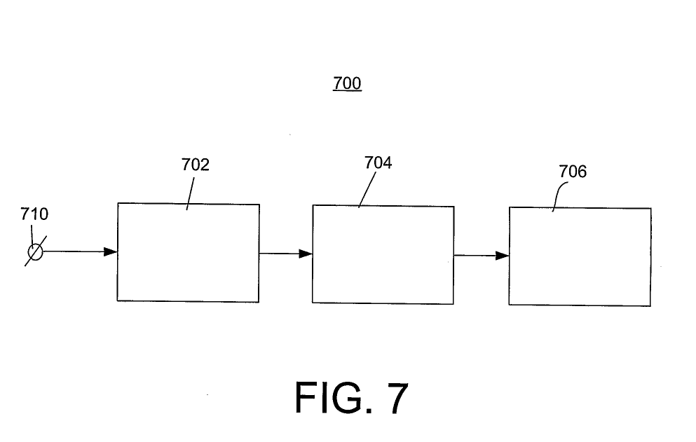

FIG. 7 schematically shows an image processing apparatus according to the invention.

Same reference numerals are used to denote similar parts throughout the Figures.

FIG. 1 schematically shows an embodiment of the image conversion unit 100 according to the invention. The image conversion unit 100 is arranged to convert an input image with an input frequency spectrum into an output image with an output frequency spectrum, the output frequency spectrum having more relatively high frequency components than the input frequency spectrum. The image conversion unit 100 comprises:

means 102 for providing an intermediate image Y on basis of the input image X; and

a combining unit 104 for combining a high frequency signal E with the intermediate image Y into the output image Z by means of error diffusion.

Typically, the image conversion unit 100 is provided with a video signal representing standard definition (SD) images at the input connector 108 and provides high definition (HD) images as output. In that case the means for providing an intermediate image Y comprises an up-scaling unit 102 which is arranged to compute an intermediate image by means of interpolation of pixel values being extracted from the input SD images. The up-scaling unit 102 may be arranged to perform an interpolation by means of fixed interpolation coefficients. Alternatively, the interpolation coefficients are determined on basis of the image content. Examples of such non-linear up-scaling methods are e.g. described in the article “Towards an overview of spatial up-conversion techniques”, by Meng Zhao et al., in the proceedings of the SCE 2002, Erfurt, Germany, 23-26 September 2002.

Alternatively, the means for providing corresponds to a receiving unit which is arranged to perform a unitary pixel operation, i.e. a copy or lookup table operation.

The combining unit 104 is arranged to add a high frequency signal, i.e. an error signal E to the input signal of the combining unit, i.e. the intermediate image Y and is further arranged to perform a dithering. This dithering is e.g. as disclosed in the article; “An introduction to digital audio”, by Hawksford, M. O, in Audio Engineering, IEE Colloquium on, Mar. 9, 1994, Pages: 1/1-114.

A preferred dithering will be briefly explained by means of an example. Suppose that the pixels of the intermediate image Y are processed by means of a scanning procedure, e.g. row by row. Suppose that the value to be added to a particular value of a particular pixel of the intermediate image Y equals 8. That means that the current value of the high frequency signal E equals 8. After adding that particular value, neighboring pixels of the particular pixel are reduced by means of subtracting computation values. The sum of the computation values equals the particular value (=8). Preferably, the compensation is applied to a limited number of the neighboring pixels which are still to be processed during the current scan. For instance if the scanning starts at the left top and proceeds row by row to the right bottom, the group of pixels being used for the compensation comprises pixels which are located at the right of the particular pixel and below the particular pixel. Preferably the group of pixels comprises pixels which are adjacent or connected to the particular pixel. Suppose that the group of pixels comprises four pixels and the amount of compensation is spread equally, then the computation values are equal to 2. That means that the value of 2 is subtracted from the pixels of the group of pixels. Subsequently, the different pixels of the intermediate image Y are processed according to this scheme.

The group of pixels are located within the aperture of the error diffusion kernel of the error filter 106. Preferably, the coefficients of the diffusion kernel are not fixed. That means that both the actual number of pixels being used for compensation is adaptive and that the weighting factors for the different pixels may be mutually different. The coefficients of the error diffusion kernel of the combining means 104 may be based on local luminance values of the intermediate image Y or the input image X. Alternatively, the coefficients of the error diffusion kernel of the combining means 104 are based on a scaling factor for the interpolation unit. With scaling factor is meant the relation between the spatial resolution of the intermediate image Y and the spatial resolution of the input image X.

The transfer function of the error filter 106 is denoted as H. Then the transfer function of the combining unit 104 is specified by Equation 1:
Z(i,j)=Y(i,j)+(1−H(i, j))(E(i, j) (1)
whereby (i, j) are coordinates of pixels, Z is the output of the combining unit 104, Y is the input of the combining unit 104 and E is the high frequency signal provided to the combining unit 104.

Preferably, a Floyd-Steinberg filter kernel is used.

FIG. 2 schematically shows an embodiment of the image conversion unit 200 according to the invention, comprising a high frequency generating unit 202. Although the high frequency signal E may be generated independent of the input image X or the intermediate image Y, it is preferred that the high frequency signal E is based on one of these images. The corresponding transfer functions of the combining unit 104 are specified is Equations 2 and 3, respectively.
Z(i, j)=Y(i, j)+(1−H(i, j))(E(X(i, j)) (2)
Z(i, j)=Y(i, j)+(1−H(i, j))(E(Y(i, j)) (3)

A preferred high frequency generating unit 202 comprises a sequence of a high pass filter 204, a clipping unit 206 and an amplification unit 208.

FIG. 3 schematically shows an embodiment of the image conversion unit 300 according to the invention, comprising a further clipping unit 302. Adding the high frequency signal E to the intermediate image Y can cause the output to reach values beyond a predetermined output range. To prevent this, the combined signal is clipped between the minimum and maximum allowed value of the output range. The embodiment of the image conversion unit 300 according to the invention as depicted in FIG. 3, further comprises a further clipping means 302 for clipping the output of the combining means. Preferably the combining means 104 is arranged to take into account the amount of clipping by the further clipping means 302. Taking into account means that the amount of compensation to be applied to neighboring pixels is based on the actual value being added to a particular pixel.

FIG. 4 schematically shows an embodiment of the image conversion unit 400 according to the invention, comprising a noise measurement unit 402. The noise measurement unit 402 is designed to control the high frequency generation unit 202. That means that the amplitude of the high frequency signal is based on the measured amount of noise. This is achieved by adapting the amplification factor A of the amplification unit 208 of the high frequency generating unit 202. In the case of transmission noise for video data the noise level can be computed on basis of information-free time-slots in the image data stream (blanking). As the only signal in these time slots is the noise, it can be measured straightforwardly. See “Interfield noise and cross color reduction IC for flicker free TV receivers”, by T. Grafe et al., in IEEE Transactions on Consumer Electronics, Vol. 34, No. 3, August 1988, pages 402-408. Alternatively the amount of noise is computed on basis of the images, e.g. by calculating the variance from a large number of areas in an image. This approach is explained in more detail in chapter 3 of the book “Video Processing for multimedia systems”, by G. de Haan, University Press Eindhoven.

Alternatively the amount of noise is determined by means of a block artefact detector, also known as a block grid detector. This type of detectors are for instance disclosed in patent applications WO01/20912A1 and WO 2004/002163A2 of the same applicant.

It should be noted that it is possible that the noise level is measured in an image of a series of input images and subsequently applied to control the addition of the high frequency signal in other images of this series of input images. A preferred noise measurement unit is described in connection with FIG. 6.

In general, the control of the high frequency generation unit 202 is such that the amount of energy which is added to the intermediate image is relatively high if the level of measured noise is relatively high. The energy is related to the amplitude of the high frequency signal. However the relation between these two quantities does not have to be linear. Besides that, the level of measured noise might also be applied to control the spectrum of the added high frequency signal. Optionally, multiple noise level measurements are performed, each focusing on distinct parts of the frequency spectrum or luminance values of the input image. By doing this, the control of the spectrum of the added high frequency signal can be further improved.

The up-scaling unit 102, the combining unit 104, the high frequency generating unit 202 and the noise measurement unit 402 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

Now, the effect in the frequency domain of the up-conversion and of the addition of the high frequency signal will be illustrated by means of an example. See FIGS. 5A, 5B and 5C. FIG. 5A schematically shows the frequency spectrum |F(f)| of an input SD image. As can be seen, there are no spectral components above the Nyquist frequency f_{Nyquist}¹ of this input SD image. FIG. 5B schematically shows the frequency spectrum of the intermediate HD image, which is based on the input SD image. The intermediate HD image has been computed by means of interpolation of pixel values being extracted from the input SD image. Although the resolution of this intermediate HD is higher than the resolution of the input SD image of which it is derived, there are hardly any spectral components above the Nyquist frequency f_{Nyquist}¹ of the input SD image. In this example a non-linear up-scaling unit 102 is applied in combination with a spatial enhancement filter. FIG. 5C schematically shows the frequency spectrum of the output HD image which comprises the added high frequency signal with frequency components in the range above the Nyquist frequency f_{Nyquist}¹ of the input SD image.

FIG. 6 schematically shows a preferred noise measurement unit 402 for the image conversion unit 400 according to the invention. The noise measurement unit 402 is provided with an input signal U at its input connector 602 and is arranged to provide a luminance and/or color dependent noise signal at its output connector 604. With luminance dependent noise signal is meant that not a single value is provided at the output connector but a noise signal which represents a noise level as function of luminance value. Such a noise signal is useful for controlling the high frequency generating unit 202 or for controlling the combining unit 104. Preferably, the amplification of the high frequency signal generating unit 202 is luminance value dependent.

Such a noise signal is obtained by performing a noise estimation for multiple luminance ranges, such as shown in FIG. 6. The input signal U is split by means of the splitting unit 606 in signals U₀, U₁, U₂, . . . , Uₙ, such that Uₖ contains the luminance range from (k−1)/n until k/n. Noise is estimated for each signal Uₖ by means of a number of noise estimators 608-604, resulting in noise estimates σ₀ till σₙ. These are combined by the noise fitting unit 616 into a luminance dependent noise signal.

FIG. 7 schematically shows an embodiment of the image processing apparatus 700 according to the invention, comprising:

Receiving means 702 for receiving a signal representing SD images. The signal may be a broadcast signal received via an antenna or cable but may also be a signal from a storage device like a VCR (Video Cassette Recorder) or Digital Versatile Disk (DVD). The signal is provided at the input connector 710;

The image conversion unit 704 as described in connection with any of the FIGS. 1-4; and

A display device 706 for displaying the HD output images of the image conversion unit 704. This display device 706 is optional.

The image processing apparatus 700 might e.g. be a TV. Alternatively the image processing apparatus 700 does not comprise the optional display device but provides HD images to an apparatus that does comprise a display device 706. It that case, the image processing apparatus 400 might be e.g. a set top box, a satellite-tuner, a VCR player or a DVD player. But it might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. An image conversion unit (100) for converting an input image with an input frequency spectrum into an output image with an output frequency spectrum, the output frequency spectrum having more relatively high frequency components than the input frequency spectrum, the image conversion unit comprising:
means for providing (102) an intermediate image on basis of the input image; and
combining means (104) for combining a high frequency signal with the intermediate image into the output image by means of error diffusion.

2. An image conversion unit (100) as claimed in claim 1, whereby the means for providing (102) an intermediate image comprises an interpolation unit for computing the intermediate image on basis of the input image whereby the resolution of the intermediate image is higher than the resolution of the input image.

3. An image conversion unit (200) as claimed in claim 1, further comprising high frequency generating means (202) for generating the high frequency signal whereby the high frequency signal comprises spectral components that are in a part of the output frequency spectrum that is above the input spectrum of the input image.

4. An image conversion unit (200) as claimed in claim 3, whereby the high frequency generating means comprises a non-linear filter for generating the high frequency signal on basis of the input image.

5. An image conversion unit as claimed in claim 2, whereby coefficients of an error diffusion kernel of the combining means are based on local luminance values of the intermediate image.

6. An image conversion unit as claimed in any claim 2, whereby coefficients of an error diffusion kernel of the combining means are based on a scaling factor for the interpolation unit, the scaling factor being based on the relation between the resolution of the intermediate image and the resolution of the input image.

7. An image conversion unit (400) as claimed in claim 1, further comprising clipping means (302) for clipping the output of the combining means and whereby the combining means (104) is arranged to take into account the amount of clipping by the clipping means.

8. An image conversion unit (400) as claimed in claim 1, whereby the image conversion unit is arranged to modulate the amplitude of the high frequency signal on basis of a noise level.

9. An image conversion unit as claimed in claim 8, whereby the noise level is computed in dependence of local luminance values of the input image.

10. An image conversion unit as claimed in claim 8, whereby the noise level is locally computed on basis of local noise measurements resulting in local noise levels for respective regions of the input image.

11. An image conversion unit as claimed in claim 10, whereby the local noise levels are computed in dependence of a block grid detector.

12. An image processing apparatus (700) comprising:
receiving means (702) for receiving a signal corresponding to an input image; and
the image conversion unit (704) for converting the input image into an output image, as claimed in claim 1.

13. An image processing apparatus (700) as claimed in claim 12, further comprising a display device (706) for displaying the output image.

14. A TV comprising an image processing apparatus (400) as claimed in claim 13.

15. A method of converting an input image with an input frequency spectrum into an output image with an output frequency spectrum, the output frequency spectrum having more relatively high frequency components than the input frequency spectrum, the method comprising:
providing an intermediate image on basis of the input image; and
combining a high frequency signal with the intermediate image into the output image by means of error diffusion.

16. A computer program product to be loaded by a computer arrangement, comprising instructions to convert an input image with an input frequency spectrum into an output image with an output frequency spectrum, the output frequency spectrum having more relatively high frequency components than the input frequency spectrum, the computer arrangement comprising processing means and a memory, the computer program product, after being loaded, providing said processing means with the capability to carry out:
providing an intermediate image on basis of the input image; and
combining a high frequency signal with the intermediate image into the output image by means of error diffusion.
